(19) United States
(12) Patent Application Publication
(10) Pub. No.: US 2025/0285617 A1
(43) Pub. Date: Sep. 11, 2025

(54) METHOD OF AUDIO PROCESSING, ELECTRONIC DEVICE, AND STORAGE MEDIUM

(71) Applicant: Beijing Zitiao Network Technology Co., Ltd., Beijing (CN)

(72) Inventors: Xiangming WANG, Beijing (CN); Rui Liu, Beijing (CN); Ming Zou, Beijing (CN)

(21) Appl. No.: 18/974,293

(22) Filed: Dec. 9, 2024

(30) Foreign Application Priority Data
Mar. 6, 2024 (CN) 202410257541.6

(51) Int. Cl. G10L 15/183; G10L 15/02; G10L 15/22

(52) U.S. Cl. CPC G10L 15/183; G10L 15/02; G10L 15/22

(57) ABSTRACT

Embodiments of the present disclosure provide a method of audio processing method, an electronic device, and a storage medium. The method includes: obtaining an intermediate feature of prompt text as a first intermediate feature, where the first intermediate feature is obtained by pre-processing the prompt text based on a language model; inputting the first intermediate feature and acquired target audio into the language model, to output, as a second intermediate feature, an intermediate feature corresponding to the target audio, where the target audio corresponds to the prompt text, and the first intermediate feature and the second intermediate feature are both cached as a key value (KV); and inputting the first intermediate feature and the second intermediate feature into the language model to generate a processing result corresponding to the target audio.

### CROSS-REFERENCE TO RELATED APPLICATION

The present disclosure claims priority of the Chinese Patent Application No. 202410257541.6 filed on Mar. 6, 2024, the disclosure of which is incorporated herein by reference in its entirety as part of the present application.

### TECHNICAL FIELD

Embodiments of the present disclosure relate to a method of audio processing, an electronic device, and a storage medium.

### BACKGROUND

With the rapid development of computer technologies, large language models (LLMs) that have emerged in recent years have attracted widespread attention due to their abilities to more intelligently understand and respond to questions raised by users. In addition, the large language models are often used to understand audio.

### SUMMARY

An embodiment of the present disclosure provides a method of audio processing. The method includes: obtaining an intermediate feature of prompt text as a first intermediate feature, where the first intermediate feature is obtained by pre-processing the prompt text based on a language model; inputting the first intermediate feature and acquired target audio into the language model, to output, as a second intermediate feature, an intermediate feature corresponding to the target audio, where the target audio corresponds to the prompt text, and the first intermediate feature and the second intermediate feature are both cached as a key value (KV); and inputting the first intermediate feature and the second intermediate feature into the language model to generate a processing result corresponding to the target audio.

An embodiment of the present disclosure further provides an audio processing apparatus. The apparatus includes: a first intermediate feature obtaining module configured to obtain an intermediate feature of prompt text as a first intermediate feature, where the first intermediate feature is obtained by pre-processing the prompt text based on a language model; a second intermediate feature obtaining module configured to input the first intermediate feature and acquired target audio into the language model, to output, as a second intermediate feature, an intermediate feature corresponding to the target audio, where the target audio corresponds to the prompt text, and the first intermediate feature and the second intermediate feature are both cached as a key value (KV); and an audio processing result generation module configured to input the first intermediate feature and the second intermediate feature into the language model to generate a processing result corresponding to the target audio.

An embodiment of the present disclosure further provides an electronic device. The electronic device includes: one or more processors; and a storage apparatus configured to store one or more programs, where the one or more programs, when executed by the one or more processors, cause the one or more processors to implement the method of audio processing according to the embodiments of the present disclosure.

An embodiment of the present disclosure further provides a storage medium including computer-executable instructions, where the computer-executable instructions, when executed by a computer processor, are used to perform the method of audio processing according to the embodiments of the present disclosure.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1 is a schematic flowchart of a method of audio processing according to an embodiment of the present disclosure;

FIG. 2 is a schematic diagram of a structure of an audio processing apparatus according to an embodiment of the present disclosure; and

FIG. 3 is a schematic diagram of a structure of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It may be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It may be understood that the data involved in the technical solutions (including, but not limited to, the data itself and the access to or use of the data) shall comply with the requirements of corresponding laws, regulations, and relevant provisions.

When audio is processed based on a large language model, prompt text and audio to be processed are first processed simultaneously, which often takes tens to hundreds of milliseconds of overhead. This time overhead significantly increases the delay in audio processing. In addition, if different pieces of audio correspond to the same prompt text, the prompt text needs to be repeatedly processed during processing of the pieces of audio, which leads to a waste of computing resources. In the embodiments, prompt text is pre-processed before audio acquisition is completed, and then acquired target audio is incrementally processed, which reduces the delay in audio processing. Moreover, for new audio, if prompt text corresponding to the audio has been pre-processed, further audio processing may be performed by directly using a processing result for the prompt text, which saves on computing resources.

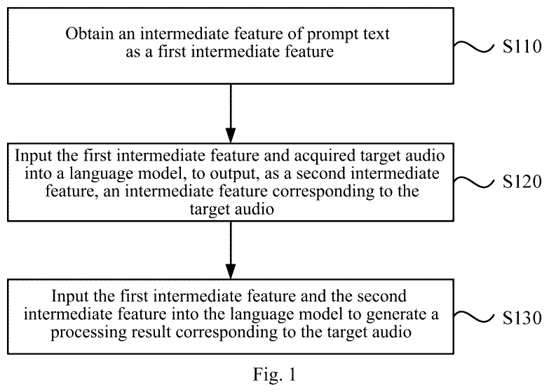

FIG. 1 is a schematic flowchart of a method of audio processing according to an embodiment of the present disclosure. This embodiment of the present disclosure is applicable to processing of an audio based on a language model. The method may be performed by an apparatus of audio processing. The apparatus may be implemented in the form of software and/or hardware, and optionally, by an electronic device. The electronic device may be a mobile terminal, a PC, a server, etc.

As shown in FIG. 1, the method includes the following steps.

S110: Obtain an intermediate feature of prompt text as a first intermediate feature.

The first intermediate feature is obtained by pre-processing the prompt text based on the language model. The language model may be a deep learning model, i.e., a large language model, trained based on massive text data, which can deeply understand the meaning of text and process a variety of natural language tasks. The prompt text may be a prompt entered by a user according to task requirements. For example: if the user wants to translate a piece of audio in Chinese into English, the prompt entered could be “Please translate the following audio into English”, i.e., the prompt text is used to prompt the language model to perform a specific task.

The first intermediate feature is cached as a key value (KV), that is, a KV cache.

In this embodiment, the language model includes a first attention module, a second attention module, and a third attention module. The first intermediate feature is obtained through processing by the first attention module of the language model. The second attention module may be understood as an incremental processing attention module.

In particular, the intermediate feature of the prompt text may be obtained by the following: obtaining, at an acquisition start moment of the target audio and from a cache, the intermediate feature of the prompt text corresponding to the target audio; and if the intermediate feature of the prompt text corresponding to the target audio is not obtained from the cache, inputting the prompt text corresponding to the target audio into the first attention module, to output the intermediate feature of the prompt text.

In this application scenario, when the user needs to process the audio, first, the prompt text for processing the audio is input through a terminal device, and then, the terminal device is used to acquire the target audio. When it is detected that the terminal device starts to acquire the target audio, the intermediate feature of the prompt text corresponding to the target audio is obtained from a cache, where the cache may be a cache in a graphics memory. If the intermediate feature of the prompt text corresponding to the target audio is obtained from the cache, it indicates that the target audio corresponds to the same processing task, i.e., the same prompt text, as historical target audio, where the prompt text has been pre-processed by the language model to obtain the intermediate feature. If the intermediate feature of the prompt text corresponding to the target audio is not obtained from the cache, it indicates that the prompt text corresponding to the target audio has not been processed or the intermediate feature of the prompt text corresponding to the target audio has been removed out of the cache. In this case, the prompt text corresponding to the target audio is input into the first attention module, to output the intermediate feature of the prompt text, i.e., a KV cache for the prompt text.

The process of inputting the prompt text corresponding to the target audio into the first attention module may be: scheduling program code corresponding to the first attention module to process the prompt text.

S120: Input the first intermediate feature and acquired target audio into the language model, to output, as a second intermediate feature, an intermediate feature corresponding to the target audio.

The target audio corresponds to the prompt text, and the first intermediate feature and the second intermediate feature are both cached as a key value (KV). The target audio may be the user's voice or other sounds. Starting from the acquisition of audio, if no more sound is acquired over a certain period of time (e.g., 5 s) or the user actively stops the acquisition, the acquisition of the target audio is completed.

In particular, the process of inputting the first intermediate feature and acquired target audio into the language model, to output an intermediate feature corresponding to the target audio may be: inputting the first intermediate feature and the acquired target audio into the second attention module, to output the intermediate feature corresponding to the target audio.

The second attention module may be understood as an incremental processing attention module. The function of incremental processing attention module may be understood as performing incremental processing on the target audio based on the first intermediate feature, to obtain the intermediate feature for the target audio, i.e., a KV cache for the target audio. The process of inputting the first intermediate feature and the acquired target audio into the second attention module may be scheduling program code corresponding to the first attention model to process the first intermediate feature and the acquired target audio.

S130: Input the first intermediate feature and the second intermediate feature into the language model to generate a processing result corresponding to the target audio.

In particular, inputting the first intermediate feature and the second intermediate feature into the language model to generate a processing result corresponding to the target audio may be implemented by: inputting the first intermediate feature and the second intermediate feature into the third attention module to generate the processing result corresponding to the target audio.

In this embodiment, the KV cache corresponding to the prompt text, and the KV cache corresponding to the target audio are input into the third attention module of the language model, to obtain the processing result for the target audio. The processing result may be text corresponding to the target audio, or text responding to the target audio, etc. The process of inputting the first intermediate feature and the second intermediate feature into the third attention module may be: scheduling program code corresponding to the third attention module to process the first intermediate feature and the second intermediate feature.

Optionally, the first intermediate feature and the second intermediate feature are both cached in a graphics memory as a key value (KV). The graphics memory may be understood as a storage space in a graphics processing unit (GPU).

The method of audio processing according to this embodiment further includes the following steps: if no new target audio is acquired for more than a set duration or an occupancy rate of the graphics memory exceeds a set threshold, removing the first intermediate feature from the graphics memory and caching the prompt text into an internal memory; or transferring the first intermediate feature from the graphics memory to the internal memory for caching.

The internal memory may be understood as a central processing unit (CPU). The set threshold may be any value between 90% and 100%, for example, 95%. If no new target audio is acquired for more than the set duration, it indicates that the task of processing the audio that is required for the user is finished. In this case, the first intermediate feature may be removed from the graphics memory while the prompt text may be cached into the internal memory, or the first intermediate feature may be transferred from the graphics memory to the internal memory for caching, to free up the space of the graphics memory, which can not only save the space of the graphics memory and improve the computing power, but can also facilitate elimination of the need for the user to re-enter the prompt text when there is the same audio processing task subsequently. If the occupancy rate of the graphics memory exceeds the set threshold, to prevent downtime, the first intermediate feature is removed from the graphics memory and the prompt text is cached into the internal memory, or the first intermediate feature is transferred from the graphics memory to the internal memory for caching.

Optionally, if the first intermediate feature is removed from the graphics memory and the prompt text is cached into the internal memory, the prompt text and the target audio are input into the first attention module when a new target audio is acquired, to output the first intermediate feature of the prompt text and a second intermediate feature of the new target audio.

In this embodiment, since the first intermediate feature corresponding to the prompt text has been moved out of the graphics memory, the prompt text and the target audio can be directly input into the first attention module when the new target audio is acquired, to output the first intermediate feature of the prompt text and the second intermediate feature of the new target audio, which eliminates the need for the user to reenter the prompt text, thereby increasing the rate of audio processing to some extent.

Optionally, after generating the processing result corresponding to the target audio, the method further includes: displaying the processing result.

In this embodiment, the processing result is displayed on the terminal device for the user to view.

According to the technical solution of this embodiment, the intermediate feature of the prompt text is obtained as the first intermediate feature, where the first intermediate feature is obtained by pre-processing the prompt text based on the language model; the first intermediate feature and the acquired target audio are input into the language model, to output, as the second intermediate feature, the intermediate feature corresponding to the target audio, where the target audio corresponds to the prompt text, and the first intermediate feature and the second intermediate feature are both cached as a key value (KV); and the first intermediate feature and the second intermediate feature are input into the language model to generate the processing result corresponding to the target audio. In the method of audio processing according to the embodiments of the present disclosure, the first intermediate feature of the prompt text that is obtained through pre-processing and the target audio are processed by means of the language model, to obtain the processing result for the target audio. The prompt text is pre-processed, which can reduce the time for processing of the prompt text, and reduce the latency of audio processing, thereby improving the efficiency of audio processing.

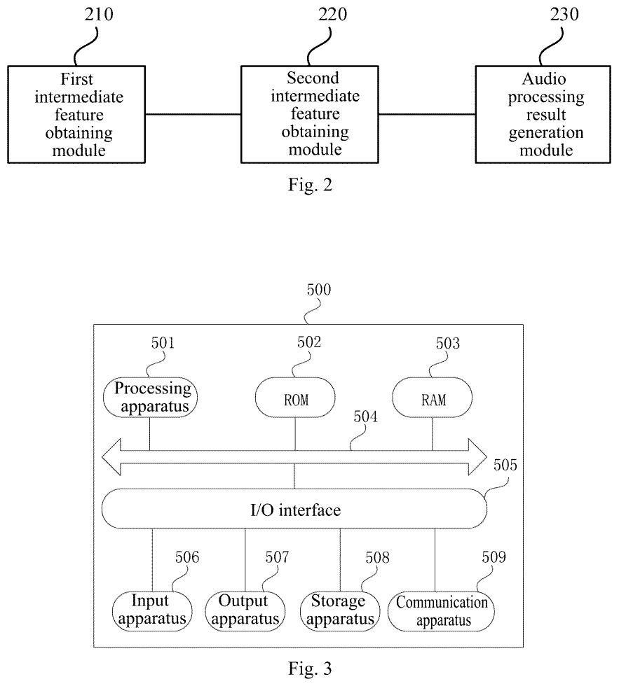

FIG. 2 is a schematic diagram of a structure of an apparatus of audio processing according to an embodiment of the present disclosure. As shown in FIG. 2, the apparatus includes:
a first intermediate feature obtaining module 210 configured to obtain an intermediate feature of prompt text as a first intermediate feature, where the first intermediate feature is obtained by pre-processing the prompt text based on a language model;
a second intermediate feature obtaining module 220 configured to input the first intermediate feature and acquired target audio into the language model, to output, as a second intermediate feature, an intermediate feature corresponding to the target audio, where the target audio corresponds to the prompt text, and the first intermediate feature and the second intermediate feature are both cached as a key value (KV); and
an audio processing result generation module 230 configured to input the first intermediate feature and the second intermediate feature into the language model to generate a processing result corresponding to the target audio.

Optionally, the language model includes a first attention module, a second attention module, and a third attention module.

Optionally, the first intermediate feature obtaining module 210 is further configured to: obtain, at an acquisition start moment of the target audio and from a cache, the intermediate feature of the prompt text corresponding to the target audio; and if the intermediate feature of the prompt text corresponding to the target audio is not obtained from the cache, input the prompt text corresponding to the target audio into the first attention module, to output the intermediate feature of the prompt text.

Optionally, the second intermediate feature obtaining module 220 is further configured to: input the first intermediate feature and the acquired target audio into the second attention module, to output the intermediate feature corresponding to the target audio.

Optionally, the third intermediate feature obtaining module 230 is further configured to: input the first intermediate feature and the second intermediate feature into the third attention module to generate the processing result corresponding to the target audio.

Optionally, the first intermediate feature and the second intermediate feature are both cached in a graphics memory as a key value (KV). The apparatus further includes a removal module configured to: if no new target audio is acquired for more than a set duration or an occupancy rate of the graphics memory exceeds a set threshold, remove the first intermediate feature from the graphics memory, and cache the prompt text into an internal memory; or transfer the first intermediate feature from the graphics memory to the internal memory for caching.

Optionally, the apparatus further includes an audio processing module configured to: if the first intermediate feature is removed from the graphics memory, and the prompt text is cached into the internal memory, input the prompt text and the target audio into the first attention module when a new target audio is acquired, to output the first intermediate feature of the prompt text and a second intermediate feature of the new target audio.

Optionally, the apparatus further includes a display module configured to display the processing result.

The audio processing apparatus according to this embodiment of the present disclosure can perform the method of audio processing according to any one of the embodiments of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

FIG. 3 is a schematic diagram of a structure of an electronic device according to an embodiment of the present disclosure. Referring to FIG. 3 below, it is a schematic diagram of a structure of an electronic device (such as a terminal device or a server in FIG. 3) 500 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 3 is merely an example, and shall not impose any limitation on the function and scope of use of the embodiments of the present disclosure.

As shown in FIG. 3, the electronic device 500 may include a processing apparatus (e.g., a central processing unit or a graphics processing unit) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 3 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 509 and installed, installed from the storage apparatus 508, or installed from the ROM 502. When the computer program is executed by the processing apparatus 501, the above-mentioned functions defined in the method of the embodiments of the present disclosure are performed.

The names of messages or information exchanged between a plurality of apparatuses in the implementations of the present disclosure are used for illustrative purposes only, and are not used to limit the scope of these messages or information.

The electronic device according to this embodiment of the present disclosure and the method of audio processing according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium having stored thereon a computer program that, when executed by a processor, causes the method of audio processing according to the above embodiments to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: obtain an intermediate feature of prompt text as a first intermediate feature, where the first intermediate feature is obtained by pre-processing the prompt text based on a language model; input the first intermediate feature and acquired target audio into the language model, to output, as a second intermediate feature, an intermediate feature corresponding to the target audio, where the target audio corresponds to the prompt text, and the first intermediate feature and the second intermediate feature are both cached as a key value (KV); and input the first intermediate feature and the second intermediate feature into the language model to generate a processing result corresponding to the target audio.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. Instead, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. Instead, the specific features and actions described above are merely exemplary forms of implementing the claims.

1. A method of audio processing, comprising:
obtaining an intermediate feature of prompt text as a first intermediate feature, wherein the first intermediate feature is obtained by pre-processing the prompt text based on a language model;
inputting the first intermediate feature and acquired target audio into the language model, to output, as a second intermediate feature, an intermediate feature corresponding to the target audio, wherein the target audio corresponds to the prompt text, and the first intermediate feature and the second intermediate feature are both cached as a key value; and
inputting the first intermediate feature and the second intermediate feature into the language model to generate a processing result corresponding to the target audio.

2. The method according to claim 1, wherein the language model comprises a first attention module, a second attention module, and a third attention module.

3. The method according to claim 2, wherein the obtaining the intermediate feature of the prompt text comprises:
obtaining, at an acquisition start moment of the target audio and from a cache, the intermediate feature of the prompt text corresponding to the target audio; and
if the intermediate feature of the prompt text corresponding to the target audio is not obtained from the cache, inputting the prompt text corresponding to the target audio into the first attention module, to output the intermediate feature of the prompt text.

4. The method according to claim 2, wherein the inputting the first intermediate feature and the acquired target audio into the language model, to output an intermediate feature corresponding to the target audio comprises:
inputting the first intermediate feature and the acquired target audio into the second attention module, to output the intermediate feature corresponding to the target audio; and
the inputting the first intermediate feature and the second intermediate feature into the language model to generate the processing result corresponding to the target audio comprises:
inputting the first intermediate feature and the second intermediate feature into the third attention module to generate the processing result corresponding to the target audio.

5. The method according to claim 2, wherein the first intermediate feature and the second intermediate feature are both cached in a graphics memory as the key value; and the method further comprises:
if no new target audio is acquired for more than a set duration or an occupancy rate of the graphics memory exceeds a set threshold, removing the first intermediate feature from the graphics memory, and caching the prompt text into an internal memory; or transferring the first intermediate feature from the graphics memory to the internal memory for caching.

6. The method according to claim 5, wherein if the first intermediate feature is removed from the graphics memory, and the prompt text is cached into the internal memory, the prompt text and the target audio are input into the first attention module when a new target audio is acquired, to output the first intermediate feature of the prompt text and a second intermediate feature of the new target audio.

7. The method according to claim 1, wherein after generating the processing result corresponding to the target audio, the method further comprises:
displaying the processing result.

8. An electronic device, comprising:
one or more processors; and
at least one storage apparatus configured to store one or more programs, wherein
the one or more programs, when executed by the one or more processors, cause the one or more processors to implement a method of audio processing, which comprises:
obtaining an intermediate feature of prompt text as a first intermediate feature, wherein the first intermediate feature is obtained by pre-processing the prompt text based on a language model;
inputting the first intermediate feature and acquired target audio into the language model, to output, as a second intermediate feature, an intermediate feature corresponding to the target audio, wherein the target audio corresponds to the prompt text, and the first intermediate feature and the second intermediate feature are both cached as a key value; and
inputting the first intermediate feature and the second intermediate feature into the language model to generate a processing result corresponding to the target audio.

9. The electronic device according to claim 8, wherein the language model comprises a first attention module, a second attention module, and a third attention module.

10. The electronic device according to claim 9, wherein the obtaining the intermediate feature of the prompt text comprises:
obtaining, at an acquisition start moment of the target audio and from a cache, the intermediate feature of the prompt text corresponding to the target audio; and
if the intermediate feature of the prompt text corresponding to the target audio is not obtained from the cache, inputting the prompt text corresponding to the target audio into the first attention module, to output the intermediate feature of the prompt text.

11. The electronic device according to claim 9, wherein the inputting the first intermediate feature and the acquired target audio into the language model, to output the intermediate feature corresponding to the target audio comprises:
inputting the first intermediate feature and the acquired target audio into the second attention module, to output the intermediate feature corresponding to the target audio; and
the inputting the first intermediate feature and the second intermediate feature into the language model to generate the processing result corresponding to the target audio comprises:
inputting the first intermediate feature and the second intermediate feature into the third attention module to generate the processing result corresponding to the target audio.

12. The electronic device according to claim 9, wherein the first intermediate feature and the second intermediate feature are both cached in a graphics memory as the key value; and the method further comprises:
if no new target audio is acquired for more than a set duration or an occupancy rate of the graphics memory exceeds a set threshold, removing the first intermediate feature from the graphics memory, and caching the prompt text into an internal memory; or transferring the first intermediate feature from the graphics memory to the internal memory for caching.

13. The electronic device according to claim 12, wherein if the first intermediate feature is removed from the graphics memory, and the prompt text is cached into the internal memory, the prompt text and the target audio are input into the first attention module when a new target audio is acquired, to output the first intermediate feature of the prompt text and a second intermediate feature of the new target audio.

14. The electronic device according to claim 8, wherein after generating the processing result corresponding to the target audio, the method further comprises:
displaying the processing result.

15. A non-transient computer-readable storage medium comprising computer-executable instructions, wherein the computer-executable instructions, when executed by a computer processor, are used to perform a method of audio processing, which comprises:
obtaining an intermediate feature of prompt text as a first intermediate feature, wherein the first intermediate feature is obtained by pre-processing the prompt text based on a language model;
inputting the first intermediate feature and acquired target audio into the language model, to output, as a second intermediate feature, an intermediate feature corresponding to the target audio, wherein the target audio corresponds to the prompt text, and the first intermediate feature and the second intermediate feature are both cached as a key value; and
inputting the first intermediate feature and the second intermediate feature into the language model to generate a processing result corresponding to the target audio.

16. The storage medium according to claim 15, wherein the language model comprises a first attention module, a second attention module, and a third attention module.

17. The storage medium according to claim 16, wherein the obtaining the intermediate feature of the prompt text comprises:
obtaining, at an acquisition start moment of the target audio and from a cache, the intermediate feature of the prompt text corresponding to the target audio; and
if the intermediate feature of the prompt text corresponding to the target audio is not obtained from the cache, inputting the prompt text corresponding to the target audio into the first attention module, to output the intermediate feature of the prompt text.

18. The storage medium according to claim 16, wherein the inputting the first intermediate feature and the acquired target audio into the language model, to output the intermediate feature corresponding to the target audio comprises:
inputting the first intermediate feature and the acquired target audio into the second attention module, to output the intermediate feature corresponding to the target audio; and
the inputting the first intermediate feature and the second intermediate feature into the language model to generate the processing result corresponding to the target audio comprises:
inputting the first intermediate feature and the second intermediate feature into the third attention module to generate the processing result corresponding to the target audio.

19. The storage medium according to claim 16, wherein the first intermediate feature and the second intermediate feature are both cached in a graphics memory as the key value; and the method further comprises:
if no new target audio is acquired for more than a set duration or an occupancy rate of the graphics memory exceeds a set threshold, removing the first intermediate feature from the graphics memory, and caching the prompt text into an internal memory; or transferring the first intermediate feature from the graphics memory to the internal memory for caching.

20. The storage medium according to claim 19, wherein if the first intermediate feature is removed from the graphics memory, and the prompt text is cached into the internal memory, the prompt text and the target audio are input into the first attention module when a new target audio is acquired, to output the first intermediate feature of the prompt text and a second intermediate feature of the new target audio.
